(19) United States
(12) Patent Application Publication
(10) Pub. No.: US 2021/0280047 A1
(43) Pub. Date: Sep. 9, 2021

(54) Personal Security App

(71) Applicant: Rich Larsen, Gjovik (NO)

(72) Inventor: Rich Larsen, Gjovik (NO)

(21) Appl. No.: 17/187,337

(22) Filed: Feb. 26, 2021

Related U.S. Application Data
(63) Continuation-in-part of application No. 16/561,316, filed on Sep. 5, 2019, now abandoned.
(60) Provisional application No. 62/727,106, filed on Sep. 5, 2018.
(60) Provisional application No. 63/152,518, filed on Feb. 23, 2021.

(51) Int. Cl. G08B 25/12; G08B 25/10; H04W 4/029; H04W 4/024; H04L 29/06

(52) U.S. Cl. CPC G08B 25/12; G08B 25/10; H04W 88/02; H04W 4/024; H04L 65/4069; H04W 4/029

(57) ABSTRACT

A personal security app for a cellphone that, on receipt of an activation signal, waits for a preselected time, then sends digital data and information to preselected destinations. The delay allows time for deactivation of false alarm. The data includes an alert message, a current location of the cellphone and images and audio captured in real-time by the cellphone's camera and microphone. The destinations may include the cellphone's local memory, a URL of a cloud based data repository, and user preselected cellphone numbers and email addresses belonging to trusted people who have agreed to act as guardians. The alarm may be activated by “pressing” an appropriate virtual button or by an audio signal such as a preselected spoken word or phrase. Other security actions may include simulating an incoming call, requesting a trusted person to monitor the user's cellphone location in real-time, or to rendezvous at a selected location.

### CROSS-REFERENCE TO RELATED APPLICATIONS

This is a US continuation-in-part application of U.S. patent application Ser. No. 16/561,316 filed on Sep. 5, 2019, entitled “System and Method for Alerting, Recording and Tracking an Assailant” that in turn claims priority to U.S. Provisional Patent Application 62/727,106 filed on Sep. 5, 2018 entitled “System and Method for Alerting, Recording and Tracking an Assailant”, and also claims priority to U.S. Provisional Patent Application 63/152,518 filed on Feb. 23, 2021 entitled “Personal Security App”, the contents of all of which are hereby fully incorporated by reference.

### BACKGROUND OF THE INVENTION

### (1) Field of the Invention

The invention relates to a software module operable on a smartphone, i.e., an app, that facilitates personal security, and more particularly to a security software module that facilitates the recording of location, audio and video data using the smartphone's hardware, alerting one or more pre-selected third parties, and transmitting the recorded data to one or more preselected locations, or addresses.

### (2) Description of Related Art

Many individuals want the freedom to explore the world as widely as possible while minimizing the risks of doing so, and consequently seek services and devices that can help provide personal security. In particular, they desire a convenient means of promptly and discreetly notifying others that they trust of any emergency or threat they are facing so that assistance may be dispatched quickly. It is also desirable that evidence of any unwanted situation is preserved for use in possible prosecutions of the persons involved. However, it is also important that the number of false alarms that are triggered are kept acceptably low so that real alarms are not ignored or minimized.

The relevant prior art includes:

US Patent Application 20180176362 of Morgan Cohen published on Jun. 21, 2018 entitled “Personal Emergency Triggering, Notification and Communication for Smartwatches” that describes a wearable mobile device [that] executes a personal safety service client application to detect a triggering event indicating an emergency, wherein the triggering event is detected from user input received by the wearable mobile device. The application determines a location of the wearable mobile device, the location of the wearable mobile device corresponding to a location of the emergency, and provides an indication of the emergency and the location of the emergency to a personal safety service server. The personal safety service server sends a notification message via a push notification displayed on user devices of a predefined group of emergency contacts indicating the occurrence of the emergency and periodically receives updates to the location of the wearable mobile device from the personal safety service client application.

International Publication Number WO 2018/107031 published by Clutch Inc. on Jun. 14, 2018 entitled “Personal Emergency Data Capture and Alerting” “that describes systems and techniques for personal emergency data capture and alerting. The personal emergency system to receive a trigger for an indication of an event on a mobile device. The personal emergency system to obtain geolocation data from a global positioning device of the mobile device and sensor data from sensors of the mobile device. The personal emergency system to determine a location of the mobile device based on the geolocation data and determine a type of event based on the sensor data and trigger used to indicate the event. The personal emergency system to store the sensor data and the geolocation data in a storage device of the mobile device and output an activation indication to the mobile device based on the type of event.

Various implementations are known in the art, but fail to address all of the problems solved by the invention described herein. Various embodiments of this invention are illustrated in the accompanying drawings and will be described in more detail herein below.

### BRIEF SUMMARY OF THE INVENTION

An inventive system and method of providing personal security that may be implemented by means of an app operating on a cellphone is disclosed.

In a preferred embodiment of the invention, the personal security app may be a software module operative on a cellphone. The app may be configured such that, on receipt of an activation signal, the cellphone may perform one or more security actions that may have been preselected by the cellphone user. These actions may include sending digital data and information to one or more preselected destinations. This digital data and information may be sent after first waiting for a preselected period of time after the activation signal is received. This delay may, for instance, provide the user an opportunity to deactivate a falsely triggered alarm. The digital data and information sent may include, but is not limited to, an alert message, a current location of the cellphone, one or more images captured in real-time by the cellphone's camera, and audio being captured in real time by the cellphone's microphone. The destinations to which the data and information is sent may, for instance, include, but is not limited to, the cellphone's local memory, an access number of a second cellphone, a URL of a cloud based data repository, an email address, or some combination thereof. These cellphone numbers and email addresses may be preselected by the user, and may belong to trusted people who have agreed to act as guardians for the user. Activation of the alarm may, for instance, be accomplished by an action such as, but not limited to, the cellphone user touching a designated area of the cellphone's touch screen, i.e., “pressing” an appropriate virtual button, or by an audio signal such as, but not limited to, a preselected word or phrase being spoken by the user, or by some combination thereof.

In further embodiments of the present invention, other security actions may also, or instead be performed. These may include actions such as, but not limited to, initiating a simulated incoming call; sending a request to a predesignated asking for a trusted person to “Follow Me”, i.e., monitor the user's cellphone location in real-time; sending a request to “Meet me here”, i.e., asking a guardian to rendezvous at a selected location; or some combination thereof. These, and other security actions, are described in greater detail below.

Therefore, the present invention succeeds in conferring the following, and others not mentioned, desirable and useful benefits and objectives.

It is an object of the present invention to enable a cellphone to be a safe and easy to use personal security tool.

It is another object of the present invention to provide personal security while protecting the user's privacy.

### BRIEF DESCRIPTION OF THE SEVERAL VIEWS OF THE DRAWINGS

FIG. 1 is a flow diagram showing representative steps in implementing an exemplary embodiment of a personal security app of the present invention.

FIG. 2 is a schematic diagram showing representative functional modules of an exemplary cellphone used to implement one embodiment of a personal security app of the present invention.

FIG. 3 is a flow diagram showing representative steps in implementing a further exemplary embodiment of a personal security app of the present invention.

FIG. 4 shows a schematic view of a representative home page of one embodiment of the personal security app of the present invention displayed on a cellphone touch screen.

FIG. 5 A shows a simulated incoming call screen of one embodiment of the personal security app of the present invention displayed on a cellphone touch screen.

FIG. 5 B shows a simulated incoming call second screen of one embodiment of the personal security app of the present invention displayed on a cellphone touch screen.

### DETAILED DESCRIPTION OF THE INVENTION

The preferred embodiments of the present invention will now be described with reference to the drawings. Identical elements in the various figures are identified, in so far as possible, with the same reference numerals. The embodiments that are described in detail are provided by way of explanation of the present invention, which is not intended to be limited thereto. In fact, those of ordinary skill in the art may appreciate upon reading the present specification and viewing the present drawings that various modifications and variations can be made thereto.

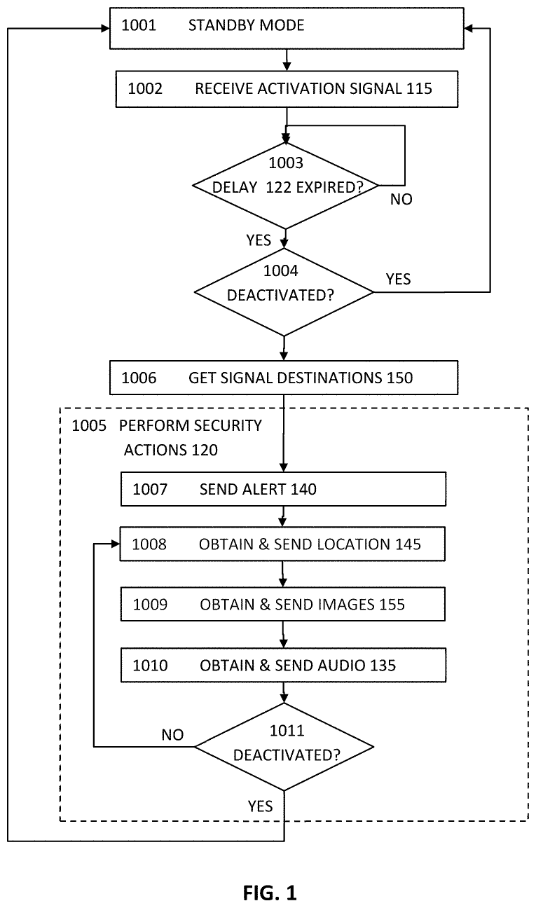

FIG. 1 is a flow diagram showing representative steps in implementing an exemplary embodiment of a personal security app of the present invention.

The personal security app, may, for instance, be a software module, that may for instance be operable on a personal digital device such as, but not limited to, a cellphone, a smartwatch, a laptop, or any other easily portable electronic device capable of supporting the appropriate communication and location determining functions.

In broad outline, the personal security app may, when activated, send digital data and information to a number of destinations. The data and information sent may include requests for help, information regarding the current location of the digital device, and images and audio being obtained in real-time by the digital device. The purpose of sending the information may include summoning immediate help as well as for storing data and information to document incidents for later examination. The destinations to which the data and information is sent may include, but is not limited to, local memory on the digital device, the cellphones of people trusted by the digital device user, and cloud based data vaults.

This broad overview of the apps functions and capabilities will now be expanded upon in more detail by examining representative steps in the operation of an exemplary embodiment of the app of the present invention in greater detail.

In Step 1001, STANDBY MODE, the personal security app may be running on a digital device such as, but not limited to, a cellphone. This may be in a background mode that may always active, or it may be activated automatically when the cellphone is turned on, or it may have been deliberately initiated by a user of the cellphone. In this mode, the app may simply be waiting for further instructions.

In Step 1002, RECEIVE ACTIVATION SIGNAL 115, the personal security app may receive a security-related activation signal 115. The activation signal may, for instance, occur as a consequence of a user action such as, but not limited to, the user pressing a specific button, selecting an designated area of the cellphone's touch screen, saying a specific word or phrase, an occurrence of a specific sound, an appearance of a specific image, shaking, or moving, the cellphone in a particular manner, or some combination thereof. When the activation signal is an audio signal, i.e., when voice activation may being used, the audio signal may, for instance, include one or more spoken words selected from a predefined list of candidate words. These candidate words may, for instance, be selected based on a criteria such as, but not limited to, an ease with which they can be recognized by audio processing software, they are not obvious trigger words, the ease with which they may be remembered, or some combination thereof.

Receipt of the security-related activation signal 115 may cause the app to move to the next step towards performing security related actions.

Step 1003 DELAY 122 EXPIRED? In this step, the app may pause for a period of time before proceeding to the next step. The length of the delay in activating the next step in the alarm sequence may be preselected by the user, or it may be preset. The approach of the end of the alarm delay may, for instance, be indicated by some suitable graphic, audio or tactile means such as, but not limited to, a count-down clock appearing on the cellphone screen, the image of an hour glass draining, a tone that may increase in loudness as the end of alarm delay approaches, or a vibration of the phone that may increase in amplitude as the end of alarm delay approaches, or some combination thereof. As long as the alarm delay has not expired, the app may loop back on itself, waiting for the expiration of the delay.

The length of the alarm delay may be preset, or it may be preselected by the user. A typical alarm delay may be of the order of three seconds, though it may be as little as one second, or as long as five seconds, or even ten seconds.

A function of the alarm delay may be to allow the user an opportunity to deactivate the app when a security-related activation signal may have been received either in error, or by mistake, and which may, therefore, trigger a false alarm unless timely deactivated.

Step 1004 DEACTIVATED? In this step, the app may check to see if the app's current mode of action has been deactivated. This deactivation may, for instance, be the result of the user taking a deactivating action such as, but not limited to, pressing an appropriate button, releasing an appropriate button, touching a designated part of the cellphone's touch screen, shaking, or otherwise moving, the cellphone in a predetermined manner, saying a specific word or phrase, an occurrence of a specific sound, an appearance of a specific image, or some combination thereof. Once deactivated the app may return to Step 1001 and be in a standby mode. Otherwise, if the app has not been deactivated, it may proceed to Step 1006.

Although Steps 1003 and 1004 are shown in the flow diagram as occurring in series, one of ordinary skill in the art may appreciate that that they may instead occur in parallel, i.e., that while waiting for the expiration of the alarm delay, the app may also be checking to see if a deactivation event has occurred, and, if so, proceed to Step 1001 without continuing to wait.

In Step 1006 GET SIGNAL DESTINATIONS 150, the app may proceed to obtain the address of destinations to which digital information may be sent. These signal destinations may be preset, or preselected, or a combination thereof. The signal destinations may, for instance, be the addresses of devices such as, but not limited to, an address of a local memory on the cellphone that may be secure, the access number of one or more second cellphones, a URL of a cloud based data repository, one or more email address, or some combination thereof. The cellphone access numbers may, for instance, be of cellphones belonging to persons trusted by the cellphone user, i.e., their “guardians” who have agreed in advance to accept security related requests, data and information from the cellphone user. These signal destinations may have been entered manually or they may be obtained by an automatic means such as, but not limited to, from one or more contact lists that may be resident on the cellphone.

Having obtained the signal destinations, the app may proceed to Step 1005 PERFORM SECURITY ACTIONS 120, in which security actions may begin to be performed. The actions to be performed may be preset, or they may be preselected by the user, or be some combination thereof.

A first of the security actions may be performed in Step 1007 SEND ALERT 140. The alert message sent in this step may, for instance, take a form such as, but not limited to, a text message, an email, a social media request, a telephone call, or some combination thereof. The alert message may be transmitted electronically to one or more of the signal destinations obtained in step 1006.

In Step 1008 OBTAIN & SEND LOCATION 145, a current location of the cellphone may be automatically obtained and sent to the selected signal destinations.

The current location of the cellphone may, for instance, be obtained using signals obtained from an electronic navigation system such as one or more of the existing, or planned, global navigation satellite systems, including, but not limited to, GPS, Galileo, GLONASS, and Beidou, or some combination thereof.

The current location may be electronically transmitted to one or more of the selected signal destinations in any suitable form including, but not limited to, well-known latitude and longitude to any suitable degree of accuracy, a street name and number, a town name, a person or a business name, a set of three words, or some combination thereof. Using three words to identify a geographical location is described in, for instance, U.S. Pat. No. 9,883,333 issued to Ganesalingamon et al. on Jan. 30, 2018 entitled “Method and apparatus for identifying and communicating locations”, the contents of which are fully incorporated herein by reference.

In a further embodiment of the invention, in addition to the geographical location, the app may cause the cellphone to obtain and record addresses, or identifiers, of electronic services currently accessible by the cellphone. These addresses, or identifiers, may also be sent, or electronically transmitted, to one or more of the signal destinations. The electronic service identifiers may, for instance, be identifiers such as, but not limited to, a Bluetooth address, a Wi-Fi address, or some combination thereof. These addresses may provide useful information not only about where the cellphone is located, but also about the identity of other people in the vicinity of the cellphone, who may be witnesses or perpetrators, or some combination thereof.

In Step 1009 OBTAIN & SEND IMAGES 155, the app may use the cellphone's camera to obtain and electronically transmit images to the selected signal destinations. The images may be obtained in real-time or they may be prestored on the cellphone, or they may be some combination thereof. The images may be any suitable digital image and may be in either color or black and white, of any suitable pixel size, and in any of the well-known digital still or video image formats. They may be encrypted and may be compressed using any of the well-known algorithms for performing such functions.

Although the app may have paused in Step 1003 to allow time for a possible false alarm to be deactivated, it may have begun recording information at that time, and that recorded information may also be sent to the selected signal destinations once the alarm activation goes live. In a further embodiment, the app may be continuously recorded information, possibly a predetermined amount of information, such as, for instance, five-minutes worth of information, so that if an alarm is activated, that prerecorded information may also be sent to the selected signal destinations. This recording, or prerecording, may, for instance, apply to all the information obtained as described in Steps 1008 through 1010.

In Step 1010 OBTAIN & SEND AUDIO 135, the app may use the cellphone's microphone to record audio signals occurring in a vicinity of the cellphone, convert the audio into suitable electronic files, and electronically convey, or transmit, those digital audio files to one or more of the selected signal destinations. The audio may be obtained “live”, i.e., in real-time, or it may be prestored on the cellphone, or it may be some combination thereof. The digital audio files may be in any of the well-known audio file formats. The digital audio files may be compressed and they may be encrypted. Audio compression or encryption may be accomplished using any of the well-known algorithms for performing such functions.

Step 1011 DEACTIVATED? In this step, the app may determine whether or not a signal to deactivate the app's current mode of action has been received. If no deactivation signal is detected, the app may loop back to Step 1008 and continue to obtain and send digital and audio data. This deactivation may, for instance, be the result of the user taking a deactivating action such as, but not limited to, pressing an appropriate button, releasing an appropriate button, touching a designated part of the cellphone's touch screen, shaking, or otherwise moving, the cellphone in a predetermined manner, saying a specific word or phrase, an occurrence of a specific sound, an appearance of a specific image, or some combination thereof. Once deactivated the app may return to Step 1001 and be in a standby mode.

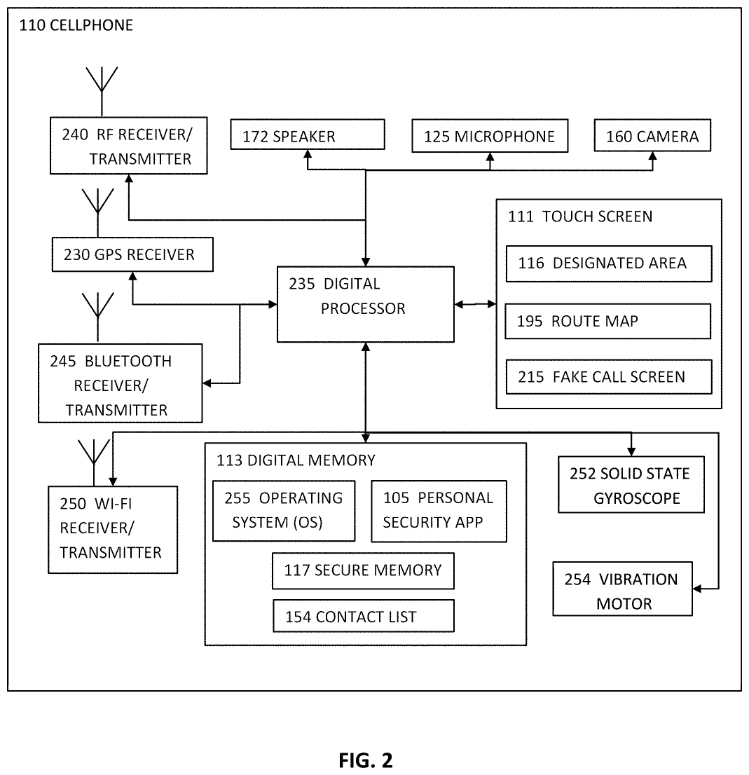

FIG. 2 is a schematic diagram showing representative functional modules of an exemplary cellphone used to implement one embodiment of the personal security app of the present invention.

The first cellphone 110, i.e., the cellphone on which the app may be operational, may be a typical cellphone which may have at its operational core a digital processor 235. The digital processor 235 may be functionally connected to a digital memory 113 in which software modules such as, but not limited to, an Operating System (OS) 255 and the personal security app 105 may reside. Once loaded into the digital processor 235, the Operating System 255 may allow the cellphone 110 to perform typical cellphone functions such as, but not limited to, interacting with the user via the cellphone's touch screen 111 to transmit and receive telephone calls, data and information. Transmission may, for instance, be performed via a Radio Frequency (RF) receiver/transmitter 240. Interaction with the user may be via a touch screen 111, a speaker 172 and a microphone 125, all of which may be functionally connected via the digital processor 235. Typical cellphones also have one or more cameras 160, as well as a GPS receiver 230, a Bluetooth receiver/transmitter 245 and a Wi-Fi receiver/transmitter 250. Cellphones may also have a solid state gyroscope 252 and a vibration motor 254.

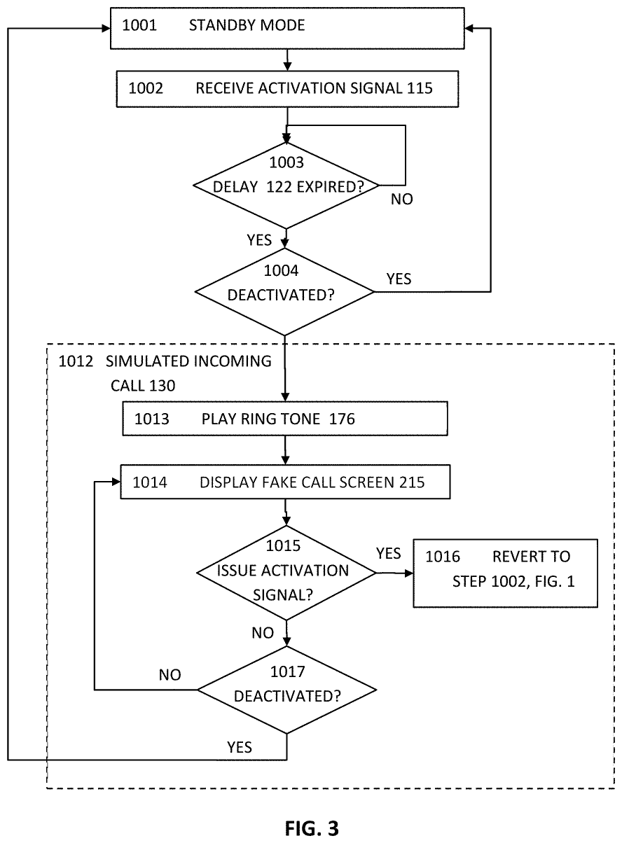

The personal security app 105 of the present invention may, for instance, be installed to reside on the cellphone's digital memory 113. When loaded onto the digital processor 235, the personal security app 105 may then operate to make use of the other functionally connected cellphone components. Using them, the app may perform the processes described in, for instance, the flow diagrams of FIGS. 1 and 3. The app may for instance use the first cellphone's touch screen 111 to display a designated area 116 that may be used as an activation button, aka as an SOS button. The cellphone's touch screen 111 may also be used to display a detailed route map 195 or a simulated incoming call screen 215, as used in, for instance, security related functions described in more detail below. The app may use the GPS receiver 230 to obtain location information, and may use the Bluetooth receiver/transmitter 245 and the Wi-Fi receiver/transmitter 250 to detect and record the presence of Bluetooth and Wi-Fi networks that are within the receiving range of the cellphone. The relative strengths of any such Bluetooth of WiFi networks may also be detected and recorded as these may provide information about how close to the user's cellphone they are. This information may also be of use in personal security functions as detailed below. The solid state gyroscope 252 may detect movement of the cellphone, and may be used by the personal security app 105 to, for instance, detect shaking, or other motion patterns that may be used as activation or deactivation signals. Similarly, the vibration motor 254 may be used by the app to alert the user that an alarm has been initiated and that the alarm will go live unless the user deactivates it. The personal security app 105 may also make use of the cellphone's digital memory 113 to store information. A local, secure memory 117 may, for instance, be one of the signal destinations 150, and may be where a history of all the information gathered and sent by the personal security app 105 may be stored. The app may also access other information stored in the digital memory 113 such as, but not limited to, a contact list 154.

FIG. 3 is a flow diagram showing representative steps in implementing a further exemplary embodiment of a personal security app of the present invention. More specifically, the flow diagram of FIG. 3 shows representative steps in implementing a simulated incoming call 130 to the cellphone. Such a call may, for instance, be a useful deterrent in a situation where the cellphone user may be in a threatening situation that may be defused simply by the potential assailant, or threat, being made aware, or reminded, that although the user may appear to alone, they may have the ability to immediately contact other people.

Steps 1001 through 1004 of the process may proceed as described in detail in the flow diagram of FIG. 1. However, when the security option selected is for a simulated incoming call 130, the app may proceed from step 1004 of having determined that no deactivation signal has been received, to Step 1012 SIMULATED INCOMING CALL 130, and proceed to initiate the simulated incoming call to said the cellphone. A first action in this process may be Step 1013 PLAY RINGTONE 176. In this step, the app may cause a speaker functionally connected to the cellphone to play a ringtone that may be the user's standard ring tone.

The app may then proceed to Step 1014 DISPLAY FAKE CALL SCREEN 215. The app may, for instance, display a fake, or simulated, incoming call screen on a touch screen that is functionally attached to the cellphone. The fake, or simulated, incoming call screen may display realistic information such as, but not limited to, a name of the incoming caller. The name of the incoming caller may be preselected by the user, or it may be automatically selected by the app from, for instance, a contact list on the users cellphone, or from a list of prior or recent callers. The automatic selection may be made at random, or it may be based on some criteria such as, but not limited to, a recency of the caller, a frequency of the caller, or some combination thereof. The simulated incoming call screen may also display buttons that may be either functional or merely decorative. The initially displayed functional buttons may, for instance, provide, functionality such as, but not limited to, call answering, call ending, activate another security related action, and switch to speaker phone, or some combination thereof. The decorative buttons may purport to provide similar functionality.

If the call answering button is selected, the app may then switch to displaying a second simulated incoming call screen that may display a second set of buttons that may also be a combination of functional buttons and merely decorative buttons. In the second simulated incoming call screen, the displayed functional buttons may, for instance, provide functionality such as, but not limited to, call ending, activate another security related action, and switch to speaker phone, or some combination thereof.

If the switch to speaker phone is selected, the app may use a speaker functionally connected to the cellphone to play prerecorded audio that may, for instance, be of the opening words or sentences spoken by a person on a previous call, or may simply be prerecorded words or sentences selected to sound like the opening sentences of a telephone conversation. In a further embodiment, the app may include a chatbot that may be response to user input and may mimic a real conversation. Such chatbots are described in, for instance, U.S. Pat. No. 7,783,486 issued to Rosser, et al. on Aug. 24, 2010 entitled “Response generator for mimicking human-computer natural language conversation”, the contents of all of which are fully incorporated herein by reference.

After displaying the simulated incoming call screen, the app may move to Step 1015 ISSUE ACTIVATION SIGNAL? In the app detects an activation signal the app may to Step 1016 REVERT TO STEP 1002, FIG. 1. In this step the app may revert to proceeding to implement the steps shown in FIG. 1, starting at Step 1002 RECEIVE ACTIVATION SIGNAL 115.

Although the simulated incoming call screens displayed in Step 1014 may have functional buttons that may allow the app to effectively switch to Step 1016, the action of Step 1015 may be to also be on the alert for the other activation signals that may be possible such as, but not limited to, the user saying a specific word or phrase, an occurrence of a specific sound, an appearance of a specific image, shaking, or moving, the cellphone in a particular manner, an appearance of a specific image, or some combination thereof.

If no request to issue an activation signal is received or detected, the app may proceed to Step 1017 DEACTIVATED? In this step the app may check for deactivation signals.

This deactivation signal may, for instance, be received as the result of the user taking a deactivating action such as, but not limited to, pressing an appropriate button, releasing an appropriate button, touching a designated part of the cellphone's touch screen, shaking, or otherwise moving, the cellphone in a predetermined manner, saying a specific word or phrase, an occurrence of a specific sound, an appearance of a specific image, or some combination thereof.

If no deactivation signal is detected, the app may loop back to Step 1014, and continue to show an appropriate simulated incoming call screen, and respond appropriately to any functional buttons that may be activated on the simulated incoming call screen.

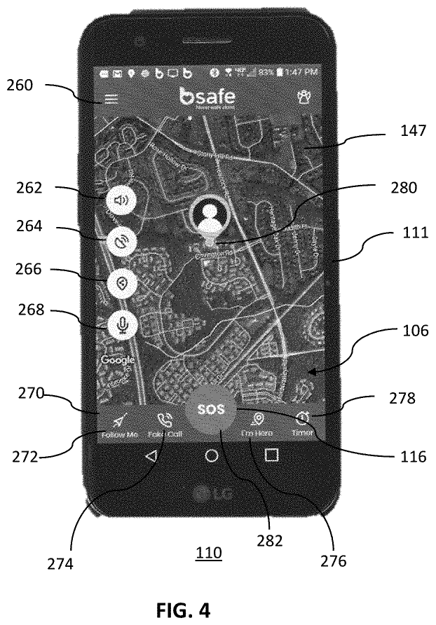

FIG. 4 shows a schematic view of a representative home page of one embodiment of the personal security app of the present invention as displayed on an exemplary cellphone touch screen.

As shown in FIG. 4, the app may utilize the cellphone 110 touch screen 111 to display a map 147 showing a current location of the cell-phone that may be indicated by a current location marker 280. The map may be overlaid with one or more functional buttons such as, but not limited to, a drop down menu 260, an audio control button 262, an location sharing button 264, a voice alarm control button 268, and a activation button panel 270.

The drop down menu 260, when opened, may allow a user to interact with the app in order to perform functions such as, but not limited to, altering their alert and contact settings, access a history of data and information obtained and stored during prior activations of the personal security app 105, alter their profile, set up voice activation features, adjust their settings, share the app with other users, sign up for premium features, access history data, obtain user help, set up an axillary button, and log off the app, or some combination thereof.

The audio control button 262 may, for instance, allow the user to optionally turn on or off the sound, i.e., turn on or off a microphone that may be functionally connected to the cellphone. The location sharing button 264 may, for instance, allow the user to optionally turn on or off any location tracking that might be enabled by the cellphone or by the app.

The location finding button 266 may, for instance, allow the user to obtain their current location, and may show that location on a map that may be displayed on the cellphone's touch screen 111.

The voice alarm control button 268 may allow the user to optionally turn on or off any of the app's voice activation functionality.

The activation button panel 270 may display one or more activation buttons such as, but not limited to, a “follow me” activation button 272, a “fake call” activation button 274, an “SOS” button 282, an “I am here” activation button 276, and a “Time to alarm” activation button 278, or some combination thereof.

The “SOS” button 282 may, for instance, be a designated area 116 of cellphone's touch screen 111 that may cause the app to begin the sequence of actions detailed in the flow diagram of FIG. 1.

The “follow me” activation button 272 may initiate a security-related activation signal that may cause the app to have the cellphone activated to perform user preselected security actions that may include sending a request to “follow me” to one or more preselected signal destinations. The request may be in a form of a message such as, but not limited to, a text message, an email, a voice message or some combination thereof. The preselected signal destination may, for instance, be an access number of a second cellphone that may belong to one of the user's trusted contacts, i.e., one of their “guardians”. The app may then wait to receive a “willing to comply” response from the signal destination, i.e., from the second cell phone. The “willing to comply” response may preferably be an appropriately worded text message, but may also, or instead, be in a form such as, but not limited to, an email, a voice message, or some combination thereof. Once the “willing to comply” response is received, the first cellphone, i.e., the user's cellphone, may then begin sending a stream of its current locations to the second cell phone at predetermined intervals. The predetermined intervals may be as little as a second, or as long as a minute, or even five minutes. In a further embodiment, the personal security app may also send the location of an intended destination to the second cell phone. On reaching the intended location, the first cell phone may also automatically send an “OK to stop following me” message to the second cell phone, and may automatically cease to send the stream of current locations to the second cell phone. In a further embodiment of the personal security app, the app may also cause the first cell phone to stream an electronic, digitized version of an audio signal captured by a microphone functionally operable on the first cellphone to the second cellphone. The app may also cause the first cell phone to stream one or more images captured in real-time by a camera functionally operable on the first cellphone to the second cellphone.

The “fake call” activation button 274 may initiate a security-related activation signal that may cause the app to have the cellphone activated to perform the security actions detailed above in connection with the flow diagram shown in FIG. 3.

The “I am here” activation button 276 may initiate a security-related activation signal that may cause the app to have the cellphone activated to perform user preselected security actions that may include sending a request to “Meet me here” to one or more preselected signal destinations, along with a location of the first cellphone, i.e., the user's cellphone. The “I am here”, or “Meet me here”, request may be in a form of a message such as, but not limited to, a text message, an email, a voice message or some combination thereof. The preselected signal destination may, for instance, be an access number of a second cellphone that may belong to one of the user's trusted contacts, i.e., their “guardians”. In a further embodiment of the security app, the app may wait for the receipt of a “Will meet you” response, and, a location of the second cellphone, i.e., the cellphone from which the “Will meet you” response was sent, to then generate a detailed route map showing how to proceed from the location of the second cellphone to the location of the first cellphone. The app may also cause the detailed route map to be sent to the second cellphone, along with an estimated time to when the meeting may occur.

The “Time to alarm” activation button 278 may allow the user to set a time after which an alarm will be activated, i.e., a time interval after which the app may enter into the sequence of actions detailed in the flow diagram shown in FIG. 1. The user may have the option to stop the clock, i.e., deactivate the alarm before the expiration of the time initially set by the user.

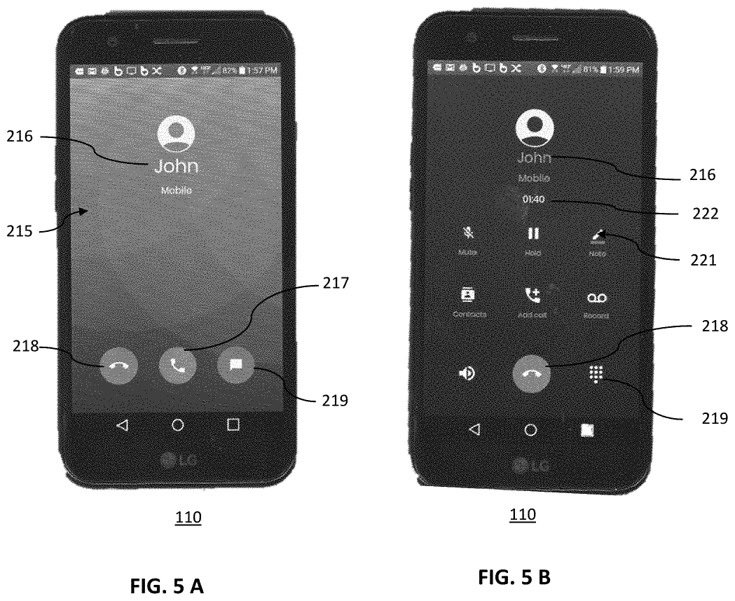

FIG. 5 A shows a simulated incoming call screen of one embodiment of the personal security app of the present invention as displayed on an exemplary cellphone touch screen.

As shown in FIG. 5 A, the cellphone 110 may display a simulated incoming call screen 215 that may include one or more buttons which may be either functional buttons or merely decorative buttons. The fake caller name 216 may, for instance, be a merely decorative button that may display a user preselected name, or the name may be automatically generated as described in more detail above in connection with the flow diagram of FIG. 3. There may also be a fake answer call button 217 that may be a functional button that, when pressed, may cause the app to display the simulated incoming call second screen 221 of FIG. 5B. There may also be a fake end call button 218 that may cause the app to have the cellphone display its normal home screen. There may also be an initiate alarm button 219 that may cause the app to initiate the security related sequence of actions detailed in the flow diagram of FIG. 1.

FIG. 5 B shows a simulated incoming call second screen of one embodiment of the personal security app of the present invention displayed on an exemplary cellphone touch screen. A screen like the one shown in FIG. 5 B may, for instance, be displayed after the user has pretended to answer the simulated incoming call by, for instance, pressing the fake answer call button 217 of FIG. 5 A. The second simulated incoming call screen may display one or more buttons which may be either functional buttons or merely decorative buttons, with the intention of mimicking the screen that may appear if a user were answering an actual incoming call. These buttons may, for instance, include buttons such as, but not limited to, a fake caller name 216, a fake call duration counter, a fake end call button 218, and a initiate alarm button 219, or some combination thereof.

In a further preferred embodiment of the invention, the SOS button detailed above may, for instance, be activated via voice recognition. Voice Activation of the SOS may, for instance, be performed by the app using user selected phrases that may, for instance, be in the English language or in any language for which suitable software packages may be available. Speech recognition may, for instance, be performed using a hidden Markov model as described in, for instance, U.S. Pat. No. 5,710,866 issued to Alleva et al. on Jan. 20, 1998, the contents of which are hereby incorporated by reference in their entirety. Using voice recognition the user may activate the SOS alarm using only their voice. This mode of activation may work even if the phone is in the user's pocket, purse, jacket, or other phone holding accoutrement. Once the SOS button is activated, the alarm functionality detailed above may be activated, and an audible alarm may be sent to one or more of the user selected guardian's cell phones and/or to an alarm center. The audible alarm may be accompanied with an accurate, current location of the cell that may be conveyed in one or more of the modalities described in detail above. If the user and their cellphone change location, they may be tracked and their current location relayed to the guardians and/or alarm center so that their whereabouts is known and shown at all times.

When activated, the voice recognition functionality may enable a user to select their own phrase in their own language such that the cell phone may detect that particular phrase as well as identifying that it is said by that particular user, i.e., the phrase has been said in their voice. In a further embodiment of the invention, the voice recognition may be language agnostic in that the recognition may rely on the components of the sound of the expected phase as spoken by the user and be able to recognize the phase as articulated by the user without resort to language identification. This may, for instance, be implemented using methods described in more detail in, for instance, U.S. Pat. No. 6,990,453 issued to Wang et al. on Jan. 24, 2006 entitled “System and methods for recognizing sound and music signals in high noise and distortion”, the contents of which are hereby incorporated by reference in their entirety.

Voice activation may be turned off or on. When voice activation is turned on, the app may listen in the background for the voiced activation command.

In a further embodiment of the invention, the app may also store personal and medical information such as, but not limited to, a user's name, address, photograph, illnesses or diseases the user suffers from, medicines the user takes, diagnoses, known allergies, blood type, donor authorizations, a list emergency contacts and/or physicians, or some combination thereof. Inclusion of such information in may be voluntary, and the information may be suitably encrypted. In emergencies, such personal and medical information as well as live video stream, location and tracking may be forwarded directly or via an alarm center to emergency response personal and agencies such as, but not limited to, the police, ambulances, hospitals, fire departments, or some combination thereof.

There may also be a clearing house functionality that may be linked to the alarm center that may linked to agencies such as, but not limited to, national emergency services in the municipality, county or country in which the cellphone may be located.

In this manner, when the SOS alarm is activated, the alarm center may receive the users personal and medical information that may be crucial in an emergency or crisis. All this information may stay encrypted on the cell phone and only become visible, or available when the SOS alarm is activated.

In a further embodiment of the invention, when interacting with emergency management systems, or crisis management systems, the app may facilitate live streaming even without activation of SOS feature. This may, for instance, be allow one or more guardians and or an alarm center to see and hear everything that is occurring in the situation as it happens in addition to knowing the exact location of the incident. This may also incorporate two-way communication and may also provides in-the-moment live information as well as post-event recording. The two-way communication may occur during streaming, and may allow the user to communicate via audio/video/text with the guardian or alarm center as well as with local authorities and emergency services such as, but not limited to, the police, hospitals, ambulance, fire departments.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A personal security app, operable on a first cellphone, said personal security app configured such that, on receipt of a security-related activation signal, said first cellphone is activated to perform user preselected security actions comprising:
sending, after the expiration of a preselected alarm delay, to one or more preselected signal destinations:
an alert message;
a current location of said first cellphone;
one or more images captured in real-time by a camera functionally operable on said first cellphone; and,
an audio signal captured in real-time by a microphone functionally operable on said first cellphone.

2. The personal security app of claim 1, wherein, on receipt of said security-related activation signal said images and said audio signal are automatically stored in a local, secure memory on said first cellphone.

3. The personal security app of claim 1, wherein, said preselected alarm delay is at least 1 second.

4. The personal security app of claim 1, wherein, said security-related activation signal comprises a user selecting a designated area of said first cellphone's touch screen.

5. The personal security app of claim 1, wherein, said security-related activation signal comprises an audio signal received via a microphone functionally operable on said first cellphone.

6. The personal security app of claim 5, wherein, said audio signal comprises one or more spoken words selected from a predefined list of candidate words, and, wherein, said preselected signal destinations comprise one or more of an access number of a second cellphone, a URL of a cloud based data repository, and an email address.

7. The personal security app of claim 4, wherein, said preselected signal destinations comprise one or more of an access number of a second cellphone, a URL of a cloud based data repository, and an email address.

8. The personal security app of claim 7, wherein said access number of a second cellphone is preselected by said user from a contact list resident on said first cellphone.

9. The personal security app of claim 1, wherein, said preselected security actions instead comprise initiating, after said preselected alarm delay, a simulated incoming call to said first cellphone.

10. The personal security app of claim 9, wherein, said a simulated incoming call to said first cellphone comprises playing, using a speaker functionally attached to said first cellphone, to play said user's standard ring tone, and said first cellphone's touch screen to display a simulated incoming call screen.

11. The personal security app of claim 10, wherein, said simulated incoming call screen is configured to be operable to issue a further security-related activation signal.

12. The personal security app of claim 1, wherein, on receipt of said security-related activation signal, said first cellphone is instead activated to perform user preselected security actions comprising sending a request to “follow me” to one or more preselected signal destinations.

13. The personal security app of claim 12, wherein, said preselected signal destination is an access number of a second cellphone, and on receipt of a “willing to comply” response from said second cell phone, sending a stream of current locations of said first cell phone at predetermined intervals to said second cell phone.

14. The personal security app of claim 13, further comprising sending the location of an intended destination to said second cell phone, and on reaching said intended location sending an OK to stop following me message to said second cell phone, and automatically ceasing to send said stream of current locations to said second cell phone.

15. The personal security app of claim 14, further comprising streaming an audio signal captured by a microphone functionally operable on said first cellphone to said second cellphone, and streaming one or more images captured in real-time by a camera functionally operable on said first cellphone to said second cellphone.

16. The personal security app of claim 1, wherein, on receipt of said security-related activation signal, said first cellphone is instead activated to perform user preselected security actions comprising sending a “Meet me here” request to a preselected signal destination, and a location of said first cellphone.

17. The security app of claim 16, further comprising, on receipt of a “Will meet you” response, and, a location of a second cellphone from which said “Will meet you” response was sent, generating a detailed route map from said location of said second cellphone to said location of said first cellphone.

18. The security app of claim 17, wherein, said user preselected security actions further comprises sending said detailed route map to said second cellphone.

19. The security app of claim 2, wherein, said user preselected security actions further comprises recording addresses of electronic services currently accessible by said first cellphone; and sending said addresses of electronic services to one or more of said preselected signal destinations.

20. The security app of claim 19, wherein, said addresses of electronic services comprise one of a Bluetooth address 212 and a Wi-Fi address 214.
